(19) United States
(12) Patent Application Publication
(10) Pub. No.: US 2010/0173107 A1
(43) Pub. Date: Jul. 8, 2010

(54) TUBE FILLED WITH AN OPEN-CELL MELAMINE/FORMALDEHYDE RESIN FOAM AND USE AS A FILTER OR STATIC MIXER

(75) Inventors: Klaus Hahn, Kirchheim (DE); Bernhard Vath, Mannheim (DE); Armin Alteheld, Bad Kreuznach (DE); Christof Möck, Mannheim (DE); Hans-Jürgen Quadbeck-Seeger, Bad Durkheim (DE)

Correspondence Address: CONNOLLY BOVE LODGE & HUTZ LLP, 1875 EYE STREET, N.W., SUITE 1100, WASHINGTON, DC, 20006, US

(73) Assignee: BASF SE, Ludwigshafen (DE)

(21) Appl. No.: 12/294,813

(22) PCT Filed: Mar. 23, 2007
(86) PCT No.: PCT/EP2007/052782

§ 371 Date: Sep. 26, 2008

(30) Foreign Application Priority Data
Mar. 28, 2006 (EP) 06111815.4

(51) Int. Cl. B32B 1/08

(52) U.S. Cl. 428/34.7; 428/36.5; 428/35.8

(57) ABSTRACT

The invention relates to a tube which has been filled with an open-cell foam based on an aminoplastic, in particular on a melamine-formaldehyde condensate, and also to its uses, in particular as filter or static mixer.

The invention relates to a tube which has been filled with an open-cell foam based on an aminoplastic, and also to its uses.

Open-cell foams based on a melamine-formaldehyde condensate are known for various thermal-insulation and soundproofing applications in buildings and vehicles, and also as an insulating and shock-absorbing packaging material. EP-A 683 349 describes pipe sheathing composed of an open-cell melamine-formaldehyde foam, where the heat resistance of the sheathing prevents it from shrinking when the pipes insulated therewith are heated.

EP-A 1 498 680 describes a freezer pack and heat-retention pack composed of melamine-formaldehyde foam whose cell pores have been filled entirely or to some extent with a flowable heat-transfer medium, and which can have a sheath which can by way of example be composed of a polyolefin foil.

It was an object of the present invention to find a simple apparatus which can filter or mix liquids and which is in particular suitable for small volumes.

Accordingly, a tube has been found which has been filled with an open-cell foam based on an aminoplastic.

Preferred open-cell foams used are elastic foams based on a melamine-formaldehyde condensate whose density is from 3 to 100 g/l, in particular from 5 to 20 g/l. The cell number is usually in the range from 50 to 300 cells/25 mm. The tensile strength is preferably in the range from 100 to 150 kPa, and the tensile strain at break is usually in the range from 8 to 20%.

For various application sectors; it can be advantageous that the open-cell foam has different pore size distribution in various tube sections, for example in the form of a linear or exponential gradient from large pores to small pores. By way of example, the cell number can be in the range from 50 to 120 cells/25 mm at one end of the tube and in the range from 150 to 300 cells/25 mm at the other end.

For its production, according to EP-A 071 672 or EP-A 037 470, a highly concentrated blowing-agent-containing solution or dispersion of a melamine-formaldehyde precondensate can be foamed and hardened using hot air, steam, or microwave irradiation.

Foams of this type are commercially available as Basotect® from BASF Aktiengesellschaft.

The molar melamine-formaldehyde ratio is generally in the range from 1:1 to 1:5. For production of particularly low-formaldehyde foams, the molar ratio is selected in the range from 1:1.3 to 1:1.8, and a precondensate free from sulfite groups is used, e.g. as described in WO 01/94436.

In order to improve performance, the foams can then be heat-conditioned and pressed. This processing step can alter the nature of the surface of the foam, the level of hydrophilic properties, the density, and the pore size. A commonly used process for thermoforming of the material uses saturation with an adhesive and hardening of the adhesive during a step in which the saturated foam undergoes forming. It is also possible to generate a thermoformable material without addition of any further auxiliary, as described in EP 1505105.

Control of the pore structure of the foam via the thermoforming process can take place via different extents of pressing of various regions of the foam. The deformed specimen can be fixed in the new shape via heating. It is possible to produce a specimen with a density gradient and pore size gradient. By way of example, a wedge-shaped specimen can be deformed using a planar press, or a planar specimen can be deformed using a wedge-shaped press, and the gradient structure of these can be fixed. It is also possible to combine two or more individual products with various degrees of compression. The resultant gradient structure or integral structure can also be advantageous with respect to mechanical properties.

The foams can be cut to the desired shape and thickness. Profile cutting are also possible and can, by way of example, give foam products with increased surface area.

The melamine-formaldehyde foams can be provided with hydrophobic and/or oleophobic properties, as described by way of example in DE10011388. Liquid-liquid separation processes can be achieved via combination of unmodified and hydrophobicized foams. It can be advantageous to combine two or more elements of this type in order to amplify the effect.

The tube, piping, and storage containers are generally composed of a material having torsional stiffness, e.g. glass, metal, or plastic, in particular of steel, aluminum, or of fiber-reinforced plastic. Suitable plastics are polyethylene, polypropylene, epoxy resins, or polyester resins, which may, if appropriate, have reinforcement by fibers, textiles, or mats, in each case composed of carbon or of glass.

The tube is generally elongate, e.g. cylindrical, and has a circular, oval, or polygonal cross section. The diameter of the tube is preferably in the range from 1 to 100 mm, particularly preferably from 5 to 50 mm. The length of the tube or, respectively, tube section filled with the open-cell foam is preferably in the range from 5 to 500 mm, particularly preferably from 10 to 100 mm.

Because the open-cell foam is elastic in the temperature range from about −180° C. to +200° C., it can easily be introduced into prefabricated tubes or container parts. Even at low temperatures, for example below −80° C., the foam remains elastic. No damage resulting from embrittlement occurs. By virtue of elasticity, heat resistance, and chemicais resistance, the inventive tube can be brought into contact over a wide temperature range with various chemicals or even with cryogenic liquids. Cryogenic liquids have a boiling point below −80° C. at atmospheric pressure. Particular preference is given to liquid air, nitrogen, hydrogen, argon, neon, helium, or liquefied engine fuels, such as propylene or natural gas, which is mainly composed of methane.

The open-cell foam is generally stamped out or cut out to provide an exact fit and introduced into the tube. However, it is also possible to insert a foam section with unequal cross section into a tube with uniform cross section. This alters the size of the cells and the number of cells per unit of volume along the tube. By way of example, a conical foam section can be inserted into a cylindrical tube in such a way that the cell size decreases continuously from one end to the other end.

The foam can also be fitted over an open end of the tube and secured externally to the tube, without protruding into the interior. It can be advantageous to use the foam as inlay in the interior of a perforated screw cap. In this case, the foam can be applied and secured simply by a screwing action.

The open-cell foam can be secured in the tube via an adhesive bond or a mechanical fastener. Sealing materials (e.g. based on silicone) can be used to compensate for inexact fit.

The tube filled according to the invention with the open-cell foam can be connected directly or by way of a further tube- or hose-connector section to a storage container. As a function of the application, it can also be combined with further filled or unfilled tubes to give a composite tube.

The inventive tube is particularly suitable as a static mixer for liquids. An example of a suitable tube here is a Y-shaped tube whose lower part or whose fork has been filled with the open-cell foam as active mixing element. The pore size and the turbulent flow through the open-cell pores permit manufacture of microreactors, via appropriate dimensioning.

A further embodiment consists in a main tube into which one or more tube portions feed. Both the main tube, or individual tube sections, and the lateral tubes can have a filling of the open-cell foam. This method permits, by way of example, two or more chemical components to be introduced by way of the lateral tubes along the main tube, and mixed and reacted. The distances between the tube-section feed points, and the tube diameter, can be adapted here to the kinetics of the reaction.

The inventive tube is also suitable for the filtering of liquids or of aerosols, for example for removal of suspended material from juices or from pre-fermentation mixtures. An example of equipment for this is a funnel into whose tubular outlet the open-cell foam has been introduced.

In another preferred method, a tube within which a conical foam section has been introduced under pressure and within which the cell structure of the inserted open-cell foam continuously changes from coarse-cell to fine-cell can be used for the filtration process. The fluid to be filtered is then applied to the coarse-cell end, whereupon the coarse suspended material is preferably absorbed first in the pores of the foam, finally the fine suspended material is absorbed. This effect reduces the pressure drop at the filter material when comparison is made with a filter composed of only small pores. The gradient structure permits distribution of the particles removed by filtration within the entire material, and avoids filter cake which is formed only on the surface and leads to a large pressure drop. Filtration of coarse particles which do not penetrate into the foam structure can be improved by enlarging the surface area of the foam product.

The inventive tube can also be utilized for the transport or controlled combustion of liquid fuels. Capillary forces cause the foam to absorb the liquid fuel, which is ignited on the surface of the foam. The wicking effect conveys the liquid fuel onward to the site of combustion, where it burns in a slow and controlled manner, but the foam does not burn or carbonize. The foam prevents any marked heating of the fuel, which would be exhausted more rapidly due to increased evaporation. Since the melamine-formaldehyde foam has low flammability, once the fuel has been consumed the foam does not itself continue to burn, but is to some extent carbonized. Because the structure of the melamine-formaldehyde resin has a high degree of crosslinking, conventional liquid fuels do not cause swelling of the polymer structure which could lead to a disadvantageous effect on mechanical properties and on fire properties.

### EXAMPLES

### Inventive Example 1

An open-cell melamine-formaldehyde foam whose density was about 10 kg/m³(Basotect® from BASF Aktiengesellschaft) was placed in a cylindrical aluminum dish whose diameter was about 3 cm and whose height was about 1.5 cm. 15 of ethanol were added to the dish comprising the foam and were ignited.

The underside of the dish with the open-cell melamine-formaldehyde foam did not undergo any significant heating and could easily be held on the hand, without burning. The burning time prior to exhaustion of the ethanol was 12.5 min. Toward the end of the combustion process, slight carbonization of the uppermost foam layer occurred. After burning had ceased spontaneously, a further 15 mL of ethanol were charged to the same dish containing the foam and ignited. The burning time decreased somewhat to 10 min. Ethanol was charged two more times to the same dish and ignited, whereupon the foam remained substantially intact. An increase in crusting of the surface, and a reduction in the burning time, were the only phenomena observed.

### Comparative Example 1

By analogy with example 1, 15 mL of ethanol were added to a dish without foam and were ignited. During the combustion process, the dish without foam, including its underside, underwent marked heating, and all of the ethanol had been exhausted after a burning time of 6.5 min.

### Inventive Example 2

A platen press using superheated steam was used to compress a rectangular, thermoformable melamine-formaldehyde foam specimen as in example 1 of EP1505105 to 50% of its initial thickness. The compressed specimen was heat-conditioned at 200° C. for 2 min and thus fixed in the compressed shape.

The mercury-intrusion volume-average pore diameter of the thermoformed specimen is 117 μm. The average pore diameter of an uncompressed comparative specimen is 170 μm.

### Inventive Example 8

A second thermoformable melamine-formaldehyde foam specimen as in example 1 of EP1505105 was cut to a wedge shape in such a way that its length was 150 mm and its width was 45 mm, its height increasing uniformly from 28 mm to 88 mm. This specimen was then pressed to a uniform height of 28 mm by means of a platen press using superheated steam. The specimen was heat-conditioned at 200° C. for 2 min and thus fixed in the compressed shape.

The heat-conditioned specimen has a gradient structure. Density and compressive strength increase continuously with rising degree of compression. The mercury-intrusion volume-average pore diameter of the thermoformed specimen is 170 μm at the end with the initial height of 28 mm. The average pore diameter of a comparative specimen from the specimen region whose initial height was 88 mm is 110 μm.

Inventive example 3 shows that the density and pore size of the foam, which are very important for filtration and capillary forces, can be adjusted in a simple manner, and that gradient structures are also possible.

### Inventive Example 4

A disk of the open-cell melamine-formaldehyde foam whose density was about 10 kg/m³ (Basotect® from BASF Aktiengesellschaft) was placed at the lower end of a 100 ml wound/blister syringe (single-use syringe). The thickness of the disk was about 20 mm, and the diameter corresponded to that of the syringe.

30 ml of each of two PU components were added from above to the single-use syringe, the top of which had been opened. The suction piston of the syringe was put in place and the previously unmixed components were pressed through the foam disk. The mixing of the reactive PU components was sufficiently intensive to cause them to react with one another and to cause formation of a homogeneous rigid polyurethane foam after injection of the reaction mixture from the syringe.

In a similar procedure but without use of foam, there was hardly any mixing of the components, and therefore only limited foaming was possible, and the foam had a very inhomogeneous structure.

Polyurethane system used:
Polyol component composed of: Polyetherol, water, tertiary amine, silicone stabilizer, blowing agent viscosity: about 1000 mPa·s (25° C.)
Isocyanate component: Lupranat M 20W (diphenyl-methane dilsocyanate) viscosity: from 155 to 235 mPa·s (25° C.)

Inventive example 4 shows that the inventive foam can be used as a simple static mixing element.

### Inventive Example 5

10 cubic specimens (10*10*10 mm) of an open-cell melamine-formaldehyde foam whose density was 9 kg/m³ (Basotect®, BASF AG) were added to a glass flask and saturated with a solution of 17.5 g of stearyl isocyanate in 332.5 g of toluene to which 5 drops of a catalyst (Lupragen N 201, BASF AG, 33% strength solution of triethylenediamine in dipropylene glycol) had been added. The solution with the saturated foam cubes was heated at reflux at 80° C. for 8 h. The toluene solution was then removed by decanting. The foam cubes were dried to constant weight, being squeezed to remove most of the absorbed liquid. The density of the hydrophoblically modified foam specimens is 18.5 kg/m³. The modified foam floats on the surface of water and is not noticeably wetted by water, and water absorption is less than 5% by volume.

A Y-shaped glass tube whose diameter was about 1 cm was secured in such a way that two openings faced downward and one opening was oriented upward. That part of the tubes oriented downward was filled with unmodified melamine-formaldehyde foam. The other part of the tubes was filled with hydrophobically modified foam. Both foam fillings extended as far as that part of the Y-shaped tube at which all three constituent tubes met.

Some water was first added through the upper opening. This was absorbed by the unmodified foam. Some toluene was then added to the glass tube via the upper tubes and was absorbed by the hydrophobically modified foam.

Selectively colored water (dye: Cu phthalocyanine complex, Basantol Blue 762 liquid, BASF AG) and about the same amount of toluene were added to a glass beaker. Chloroform was added stepwise to the mixture until the density of the colorless organic phase and of the colored aqueous phase had become sufficiently close that at least 5 seconds were required for complete separation of the mixture into two phases after the mixture had been stirred. The liquid mixture was again stirred and immediately added to the filled glass tube. The liquid mixture was observed to separate in the glass tube. The colored aqueous phase flowed out by way of the part filled with unmodified foam, whereas the colorless organic phase flowed out by way of the part of the tube with hydrophobically modified foam.

1-10. (canceled)

11. A tube, filled with an open-cell foam based on an aminoplastic, wherein the open-cell foam has a different pore size distribution in various tube selections.

12. The tube according to claim 11, wherein the bulk density of the open-cell foam is in the range from 3-100 g/l.

13. The tube according to claim 11, wherein the open-cell foam is composed of a melamine-formaldehyde resin.

14. The tube according to claim 11, wherein the cell structure of the open-cell foam continuously changes from coarse-cell to fine-cell.

15. The tube according to claim 11, where a wall of the tube is composed of glass, metal or plastic.

16. The tube according to claim 11, wherein the diameter of the tube is in the range from 1 to 100 mm, wherein the length of the tube section filled with the open-cell foam is in the range from 5 to 500 mm.

17. The tube according to claim 12, wherein the open-cell foam is composed of a melamine-formaldehyde resin.

18. The tube according to claim 12, wherein the cell structure of the open-cell foam continuously changes from coarse-cell to fine-cell.

19. The tube according to claim 13, wherein the cell structure of the open-cell foam continuously changes from coarse-cell to fine-cell.

20. The tube according to claim 12, wherein a wall of the tube is composed of glass, metal or plastic.

21. The tube according to claim 13, wherein a wall of the tube is composed of glass, metal or plastic.

22. The tube according to claim 14, wherein a wall of the tube is composed of glass, metal or plastic.

23. The tube according to claim 12, wherein the diameter of the tube is in the range from 1 to 100 mm, wherein the length of the tube section filled with the open-cell foam is in the range from 5 to 500 mm.

24. The tube according to claim 13, wherein the diameter of the tube is in the range from 1 to 100 mm, wherein the length of the tube section filled with the open-cell foam is in the range from 5 to 500 mm.

25. The tube according to claim 14, wherein the diameter of the tube is in the range from 1 to 100 mm, wherein the length of the tube section filled with the open-cell foam is in the range from 5 to 500 mm.

26. The tube according to claim 15, wherein the diameter of the tube is in the range from 1 to 100 mm, wherein the length of the tube section filled with the open-cell foam is in the range from 5 to 500 mm.
